(19) United States
(12) Patent Application Publication
(10) Pub. No.: US 2007/0090615 A1
(43) Pub. Date: Apr. 26, 2007

(54) Bowling roller bag

(76) Inventor: Fu-Hsing Tan, DongGuan (CN)

Correspondence Address: Fu-Hsing Tan, apt 201, 14401 hanging moss circle, Tampa, FL, 33613, US

(21) Appl. No.: 11/259,993

(22) Filed: Oct. 26, 2005

(51) Int. Cl. B62B 1/00

(52) U.S. Cl. 280/47.17

(57) ABSTRACT

This invention refers to a new kind of bowling roller bag comprising a pull bar, a base and two wheels. The wheels are fixed at the lower part of the corner of the base, and the pull bar is hidden or reaches out of the base. In side the base hang bowling holders which are connected with the base with rotatable axes, and there is also a stand support at the outside of the base. With such a structure, the bowling can be held in the bag stably and will never fall off no matter the bag is laid level, slanted or vertical to the ground.

### FIELD OF THE INVENTION

The present invention relates to technique of sports equipment, especially to a new kind of bowling roller bag which is easy to carry with bowling in.

### BACKGROUND OF THE INVENTION

It is quite often to carry relevant facilities in sports, for example, one may carry bowling from a place to another in bowling sport. Therefore, for convenience's sake, there has already been bowling bags as displayed in FIG. 6 wherein the bag consists of a pull bar 1, the base 2, and the wheels 3. The wheels 3 are placed at the lower part of the corner of the base 2, and the pull bar 1 can be inserted in and pulled out of the base 2; inside the base 2 there are trays 4 on which bowling can be placed; and the trays 4 are fixed at the bottom of the base 2. The foresaid structure to some degree makes it convenient to carry the bowling. However the trays 4 can hold only a small part of the bottoms of the bowling. Therefore, when the bag is laid level to the ground or at a fairly small angle to the ground, the bowling can stay stable on the trays as showed in FIG. 6, but when the bag is laid or moved as showed in FIG. 7, the bowling will fall off because of gravitation. Though those bags have belt to tie the bowling, but it makes loading and taking bowling inconvenient. Furthermore, the balls will still fall during moving because they are round and they are very heavy. Besides, presently bowling bags can only be placed levelly or vertically to the ground, and if the ground is not plain, the bags can not be laid stably.

### SUMMARY OF THE INVENTION

A main feature of the present invention is to provide a new kind of bowling roller bag in which bowling can be laid stably.

Another feature of the present invention is to provide a new kind of bowling roller bag which can be laid stably with a stand support.

According to one embodiment of the invention, to attain the objects of this invention, the technique plan consists of a pull bar which is hidden in the base or reaches out of the base, the base of the bag in which bowling holders are fixed rotatablely, and the wheels which are fixed at the lower part of the corner of the base. In detail, the bowling holders are connected with the inner side of the bag with rotatable axes; the holder is a spherical or cambered surface; there are three or more holders and there is a gap between parts where holders are connected with the inner side of the body.

In an embodiment, to attain the object of this invention, the technique plan consists of a pull bar which is hidden in the base or reaches out of the base, two wheels which are fixed at the lower part of the corner of the base, and a base at the external side of whose bottom there is a tilted stand support, which consists of two stand legs, a supporting base, a switch, and a thin steel wire. The supporting base is fixed stably at the external side of the bottom; the end of each stand legs is connected with either end of the supporting base; the switch, which can move upwards and downwards, is harnessed at the middle part of the supporting base; and the switch connects with the stand legs with a thin steel wire. In detail, the two stand legs are not in parallel, and the thin steel wire is connected with the stand legs near the places where the bars are connected with the ends of the supporting base.

According to this invention, the bowling holders are connected with the bag rotatably, which makes it possible that the bowling can keep vertical to the ground due to gravitation no matter the bag is laid level, vertical or slanted to the ground. Besides, there is no need to tie the bowling in such a bag, which makes it convenient to load and take the bowling. Furthermore, the stand support makes it possible to lay the bag stably no matter the ground is plain, rough or a slope.

### DESCRIPTION OF THE DRAWINGS

For the purpose of making the invention easier to understand, several particular embodiments thereof will now be described with reference to the appended drawings in which:

FIG. 1 is the 3-D picture of the bowling roller bag being supported according to this invention;

FIG. 2 is the 3-D picture from another visual angle of the bowling roller bag being supported according to this invention;

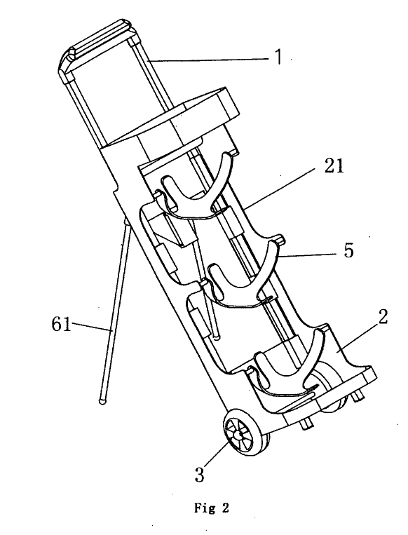

FIG. 3 is the 3-D picture of the bowling roller bag laid vertically according to this invention;

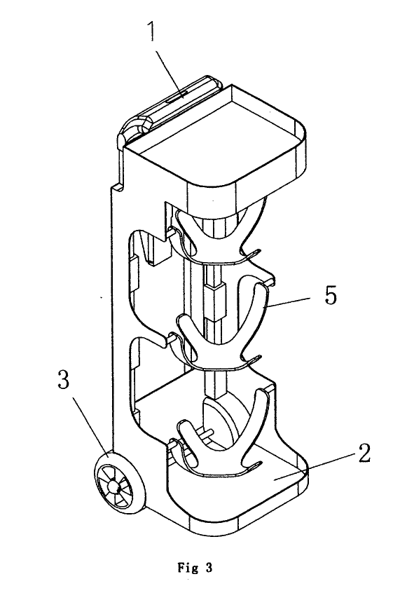

FIG. 4 is the 3-D picture from another visual angle of the bowling roller bag laid vertically according to this invention;

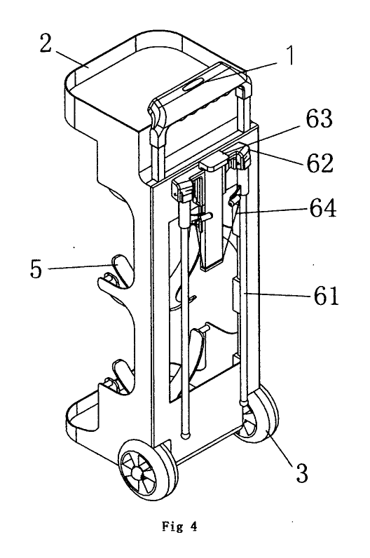

FIG. 5 is the 3-D picture of the bowling roller bag laid levelly according to this invention;

FIG. 6 is the 3-D picture of the bowling roller bag laid levelly according to normal bowling bags;

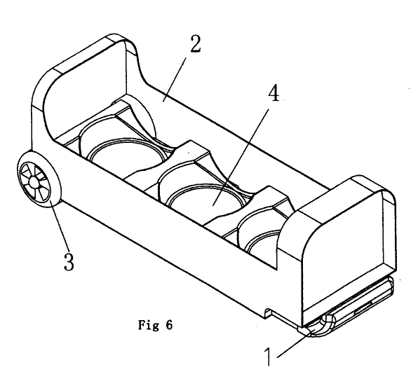

FIG. 7 is the 3-D picture of the bowling roller bag laid vertically according to normal bowling bags;

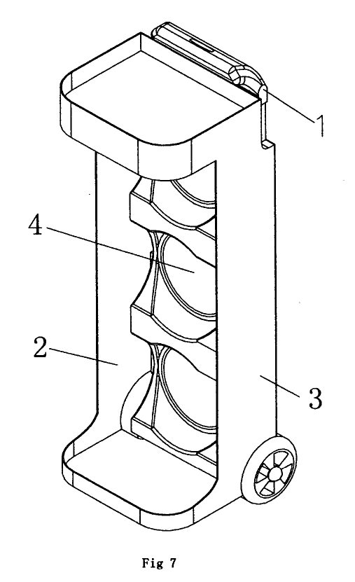

FIG. 8 is the 3-D picture of the bowling roller bag according to this invention.

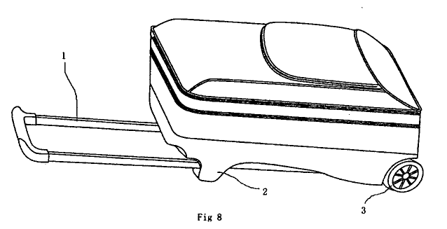

### DETAILED DESCRIPTION OF THE INVENTION

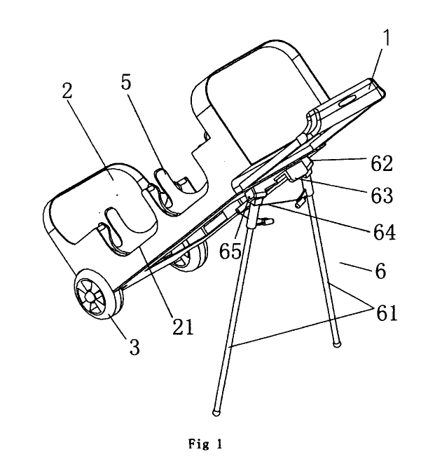

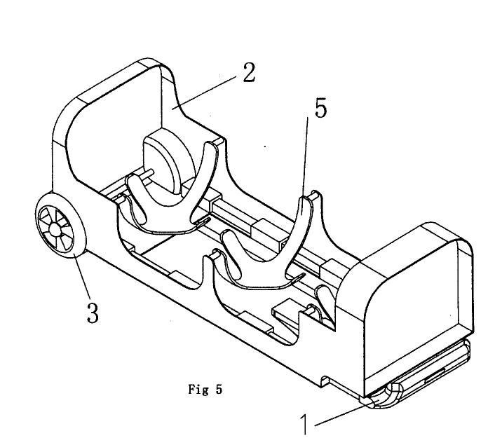

As illuminated in FIG. 1˜FIG. 5, this invention mainly includes a pull bar 1, a base 2, two wheels 3 and three bowling holders 5. The wheels 2 are fixed at the lower part of the corner of the base 2, and the pull bar 1 is hidden in or reaches out of the base 2. When it is necessary to pull the bag, the pull bar 1 can be pulled out and let the wheels touch the ground, then the bag can be pulled along at easy Inside the base 2 there are 3 bowling holders 5 hanging evenly. Of course in this invention we just take 3 holders for example. The quantity of the holders is not limited to three; it can also be two or more. The holders are connected with the inner sides of the bag with rotatable axes, and the holder is a spherical or cambered surface. When bowling are placed on the holders, they can always keep vertical to the ground because of gravitation no matter how gradient the bag is to the ground as showed in FIG. 1˜FIG. 5. And in such a way, the bowling will always stay stable on the holders and will never fall off the holders no matter the bag is laid level, slanted or vertical to the ground. Gaps 21 can be made at places where the holders are connected with the inner sides in order to reduce material and cost as well as to increase the softness of the base.

As illuminated in FIG. 1˜FIG. 5, a stand support 6 can be fit at the external side of the bottom of the base 2. The stand support 6 consists of two stand legs 61, a supporting base 62, a switch 63 and a thin steel wire 64. The supporting base is fixed at the external back side of the base 2, while the end of each stand legs 61 is separately connected with either end of the supporting base 62. There is an angle between the stand legs 61 and the connection axes 65 of the supporting base 62. When the stand legs 61 are opened, the distance between the other ends can be increased so as to strengthen the stability of the support. The switch 63 is connected with the stand legs 61 with a thin steel wire 64. The thin steel wire is connected with the stand legs 61 near the places where the stand legs 61 are connected with the supporting base 62. When the switch 63 moves upwards from the bottom, it drives the thin steel wire 64 to move upwards, and the connection parts of the thin steel wire 64 and the stand legs 61 move upwards as well so that the stand legs 61 circle around the connection axes 65 and open. When the stand legs 61 open, the bowling roller bag can be stand in an angle with the stand support. When it is necessary to close the stand support 6, it is only necessary to move the switch 63 downwards to make the stand legs 61 close at the opposite direction as illuminated before.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A new kind of bowling roller bag, comprising:
a pull bar,
a base,
two wheels;
wherein the pull bar is hidden or reaches out of the bag, and the wheels are fixed at the lower part of the corner of the base;
and inside the base hang bowling holders that are connected with the inner side of the base with rotatable axes.

2. The bowling roller bag as claimed in claim 1, wherein the bowling holders are connected with the inner side of the base with rotatable axes.

3. (canceled)

4. (canceled)

5. (canceled)

6. A new kind of bowling roller bag, comprising:
a pull bar,
a base,
two wheels;
wherein the pull bar is hidden or reaches out of the bag, and the wheels are fixed at the lower part of the corner of the base;
and at the lower part of the bottom of the base there is a stand support which consists of two stand legs, a supporting base, a switch and a thin steel wire; the supporting base is fixed stably at the external back side of the base; the end of each stand legs is connected with either end of the supporting base; the switch, which can move upwards and downwards, is harnessed at the middle part of the supporting base; and the switch connects with the stand legs with a thin steel wire.

7. The bowling bag as claimed in claim 6, wherein there is an angle between the two connection axis which connect the stand legs with the supporting base.

8. The bowling bag as claimed in claim 6, wherein the thin steel wire connects with the stand legs near places where the stand legs are connected with the supporting base.

9. The bowling roller bag as claimed in claim 1, wherein the bowling holder is a spherical or cambered surface.

10. The bowling roller bag as claimed in claim 2, wherein the bowling holder is a spherical or cambered surface.

11. The bowling roller bag as claimed in claim 1, wherein there are three or more bowling holders in the base.

12. The bowling roller bag as claimed in claim 2, wherein there are three or more bowling holders in the base.

13. The bowling roller bag as claimed in 1, wherein there is a gap between the connection parts where the bowling holders are connected with the inner side of the base.

14. The bowling roller bag as claim 2, wherein there is a gap between the connection parts where the bowling holders are connected with the inner side of the base.
